(19) United States
(12) Patent Application Publication
(10) Pub. No.: US 2023/0153328 A1
(43) Pub. Date: May 18, 2023

(54) SYSTEM AND METHOD FOR REAL-TIME CUSTOMER CLASSIFICATION

(71) Applicant: Microsoft Technology Licensing, LLC, Redmond, WA (US)

(72) Inventors: Michael Dean LUCARELLI, Sammamish, WA (US); Nitin SOOD, Redmond, WA (US); Joyce Stanley EASTAFF, Redmond, WA (US)

(73) Assignee: Microsoft Technology Licensing, LLC, Redmond, WA (US)

(21) Appl. No.: 17/528,857

(22) Filed: Nov. 17, 2021

(51) Int. Cl. G06F 16/28

(52) U.S. Cl. CPC G06F 16/285

(57) ABSTRACT

A method for classifying a tenant as being associated with one of a plurality of customer categories includes receiving a request to classify a tenant as being associated with one of a plurality of customer categories, dynamically retrieving from one or more data source systems, a plurality of data signals associated with the tenant, one or more of the plurality of data signals being stored as individual properties for the tenant in the one or more data source systems, dynamically identifying, in real-time, the tenant as being associated with one of the plurality of customer categories based at least on the plurality of data signals, and storing the identified one of the plurality of customer categories as a classification data signal for the tenant.

### BACKGROUND

Companies offering software products often have many different types of customers.

Those customers may include individual users as well as organizations that one or more users. Those organizations may be associated with different types of businesses. For example, some organizations may be in the field of education, while other organizations may be associated with health. Other organizations may be governmental entities, while still others are commercial businesses. The type of business a customer is classified within may affect the types of services and products offered to the business, as well as the amount of money charged for those services and products.

For companies that have many customers (e.g., thousands or millions of customers), keeping track of and correctly identifying the type of business each customer is classified with can be a time consuming and complex process. That is because many businesses are complex entities having different departments that could themselves be classified as different types of businesses. For example, a large commercial customer may be in the finance industry while having an education department that focuses on employee training. Moreover, businesses may change focus. Thus, an initial identification of a customer as an educational entity may no longer be accurate after a few years when the customer decides to venture into commercial activities. As a result, to accurately classify the type of organization to which an entity belongs, human intervention and examination are often needed. Moreover, this may need to occur periodically for each customer to ensure that the classification is still accurate. However, for companies having significantly large numbers of customers, examination of each customer's classification can be time and labor prohibitive. This may result in many inaccurate classifications of customers. Such inaccuracies can lead to inaccurate fee structures for many customers, inadequate or incorrect service or product offers and sales, and may result in overall customer dissatisfaction.

Hence, there is a need for improved systems and methods for classifying customers in real-time.

### SUMMARY

In one general aspect, the instant disclosure describes a data processing system having a processor, and a memory in communication with the processor where the memory comprises executable instructions that, when executed by the processor, cause the data processing system to perform multiple functions. The functions may include receiving a request to classify a tenant as being associated with one of a plurality of customer categories, dynamically retrieving from one or more data source systems, a plurality of data signals associated with the tenant, one or more of the plurality of data signals being stored as individual properties for the tenant in the one or more data source systems, dynamically identifying, in real-time, the tenant as being associated with one of the plurality of customer categories based at least on the plurality of data signals, and transmitting for storage the identified one of the plurality of customer categories as a classification data signal for the tenant.

In yet another general aspect, the instant disclosure describes a method for classifying a tenant as being associated with one of a plurality of customer categories, where the method includes the steps of receiving a request to classify the tenant as being associated with one of a plurality of customer categories, dynamically retrieving from one or more data source systems, a plurality of data signals associated with the tenant, one or more of the plurality of data signals being stored as individual properties for the tenant in the one or more data source systems, dynamically identifying, in real-time, the tenant as being associated with one of the plurality of customer categories based at least on the plurality of data signals, and transmitting for storage the identified one of the plurality of customer categories as a classification data signal for the tenant.

In a further general aspect, the instant disclosure describes a non-transitory computer readable medium on which are stored instructions that when executed cause a programmable device to perform functions of receiving a request to classify a tenant as being associated with one of a plurality of customer categories, dynamically retrieving from one or more data source systems, a plurality of data signals associated with the tenant, one or more of the plurality of data signals being stored as individual properties for the tenant in the one or more data source systems, dynamically identifying, in real-time, the tenant as being associated with one of the plurality of customer categories based at least on the plurality of data signals, and transmitting for storage the identified one of the plurality of customer categories as a classification data signal for the tenant.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system upon which aspects of this disclosure may be implemented.

FIG. 2 depicts example data sources used in classifying customers.

FIG. 3 depicts an example of some data fields for parameters that may be stored for a given offer ID.

FIG. 4 depicts an example of some data fields for parameters that may be stored for a given SKU ID.

FIG. 5 is a flow diagram showing an example method for dynamically classifying a tenant as being associated with one of a plurality of customer categories.

FIG. 6 is a block diagram illustrating an example software architecture, various portions of which may be used in conjunction with various hardware architectures herein described.

FIG. 7 is a block diagram illustrating components of an example machine configured to read instructions from a machine-readable medium and perform any of the features described herein.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

Software provider companies and in particular cloud service providers often make their products and/or services available to many different types of organizations. These organizations may include small and medium-sized organizations, as well as large organizations which may have thousands of users. The type of organization and/or the industry with which an organization is associated may be an important factor in the types and levels of services, products, licenses, features, support, fee structures, and the like provided to the organization. For example, many large software providers offer discounts to educational entities. As another example, software providers may provide additional features, updates and/or services to their large customers. As a result, accurately classifying the type of organization a customer belongs to is an important business parameter for many software providers. However, correctly classifying a customer may require examination of different parameters.

Currently, many software providers classify their customers based on static parameters. For example, a type of organization may be assigned to a customer when they first purchase a product or service and the type may remain the same for a long period of time, even though the customer's business may change and/or evolve over time. As a result, many classifications may be incorrect and obsolete. Thus, there exists a technical problem of static and outdated classification of customers.

Moreover, current processes of classifying customers rely heavily on human input and examination. For companies that have significantly large number of customers, the process of manually evaluating parameters relating to customer classifications is time-consuming and labor-intensive, and as such is often overlooked. This is true in particular for smaller and medium-sized customers who may make up a majority of the companies' customers, but may not be large enough to warrant manual examination. Thus, there exists another technical problem of lack of processes that reduce the amount of human input required to accurately classify customers.

To address these technical problems and more, in an example, this description provides a technical solution of dynamically classifying tenants into customer segments based on real-time signals associated with the tenants. The signals may include actual transactions that involve the tenants in the system. The signals may be stored as individual properties of each tenant. and may be retrieved dynamically at runtime. A customer's segment may then be determined and assigned dynamically based on a number of signals associated with the tenant. This may result in a customer classification which is dynamic and determined in real-time. This classification may be a destructive data dimension, such that the current underlying signals are presumed to be more accurate than on any historical data. In this manner, a tenant's current classification may appear in the data for that tenant regardless of any historical date queried. This eliminates the need to store substantial amounts of data, create historical snapshots of data, and/or run restatements of data when there is a need for making a change to the underlying data structure. This reduces processing, memory and bandwidth requirements and as such is an improvement to the cloud computing environment.

As will be understood by persons of skill in the art upon reading this disclosure, benefits and advantages provided by such technical solutions can include, but are not limited to, a solution to the technical problems of having inefficient and inaccurate customer classifications that are memory and processing resource intensive in complex data and computing system environments. Technical solutions and implementations provided herein optimize and improve the process of classifying customers into multiple segments, and as such significantly improve operations of computer systems associated with storing and processing data related to customer classification. Moreover, the technical solutions provide technical advantages of reducing or eliminating the need for preservation of historical snapshots of customer classifications, reducing or eliminating the need for restatements of data.

As used herein, the term “customer” or “tenant” may refer to an organization having a plurality of computer users who utilize computer software programs acquired (e.g., licensed or purchased) by the organization. The organization may be a small, medium size or large organization. The term “software provider company” may refer to any organization that develops, offers for sale, sells, or licenses computer software programs and/or services such as cloud services. Moreover, the term “segment” may refer to a category among a plurality of categories for classifying customers. Additionally, the term “restatement” may refer to reprocessing of one or more portions of data.

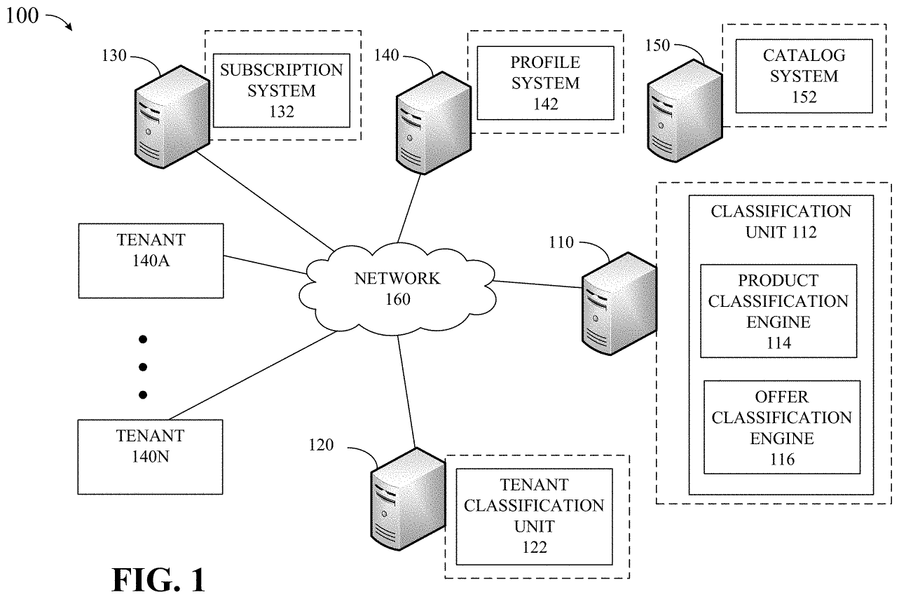

FIG. 1 depicts an example system 100 upon which aspects of this disclosure may be implemented. In different implementations, the system 100 may include a classification server 110, a tenant classification unit 120, a subscription server 130, a profile server 140, and a catalog server 150. The servers 110, 110, 120, 130, 140 and 150 may form part of an enterprise's computer system environment. The enterprise may be an enterprise that offers products and/or services for sale. The products and services may include software products.

Each of the servers 110, 120, 130, 140 and 150 may operate as shared resource servers located at an enterprise accessible by various computer client devices and/or other servers within the enterprise. Although shown as one server, each of the servers 110, 120, 130, 140 and 150 may represent multiple servers for performing various operations. For example, the classification server 110 may include one or more processing servers for performing different classification operations. In another example, the profile server 140 may include or represent multiple storage servers, each having one or more data stores for storing different types of profile data (e.g., tenant profile data, subscription profile data, etc.). Furthermore, although shown as separate servers, two or more of the servers 110, 120, 130, 140 and 150 may be combined into one server. For example, the servers 120 and 130 may be combined such that tenant classification and classification of products and offers may be performed by the same server.

Each of the servers 130, 140 and 150 may operate as storage servers and may include one or more data stores. The data stores may function as repositories in which different types of data may be stored. For example, the subscription server 130 may include one or more data repositories for storing data relating to customer subscriptions. As such, one or more of the servers 130, 140 and 150 may represent a data source system which include one or more data sources. The data sources may include transactional and/or provisioning data sources and may be stored in one or more data stores of the servers 130, 140 and 150. In some implementations, each of the data sources are associated with their own data store and may contain a variety of sets of data.

The data source systems may be authoritative for tenant identity, commerce subscriptions, and commerce catalog. In an example, data source systems 132, 142 and 152 may include data sources such as Azure® Active Directory (AAD), Microsoft® Account (MSA), commerce, Office® License Service (OLS), device census, and Sales.

The data stored by the data source systems 132, 142 and 152 may be organized into various data profiles. Each data profile may represent a different type of entity. These entities may include enterprises (e.g., tenants), subscriptions (e.g., subscriptions to various software applications), actions, licenses, orders, offers, service plans, SKUs and the like. In an example, categories of data profiles include tenant profile, subscription profile, product profile, service profile and offer profile.

The classification server 110 may include and/or execute a classification unit 112, while the tenant classification server 120 may include and/or execute a tenant classification unit 122. The classification unit 112 may function as a classifier responsible for classifying products and/or services, as well as offers provided to customers by an enterprise (e.g., software development or software provider company). Classification may include classifying a product, service and/or offer into one of a plurality of categories. The categories may include customer categories such as education, government, non-profit, health, financial and/or commercial. Each of the categories may include subcategories. For example, the government category may include major federal government, small and medium federal government, major state government, medium and small state government and local government. The commercial category may include major corporate, medium-size corporate and small corporate. In another example, the commercial category includes major education, major federal government, major financial services, major health, major state and local government, strategic health, strategic public sector, small and medium corporate, and education unmanaged.

The process of classifying products, services and/or offers into one or more categories may include designating a category and a subcategory to a service, product or offer. This may involve retrieving data about products and/or services available and/or offers made by an enterprise to obtain information about those products, services and/or offers. This may be achieved by querying the catalog system 152 which may include one or more data sources relating to products, services and/or offers of the enterprise.

Once information about those products, services and/or offers is retrieved, the classification unit 112 may utilize a product classification engine 114 to classify products and/or services. This may be done by examining information about the products and services to determine if there are categories associated with the products and services that can be used to classify them. In some implementations, the catalog data about the products and/or services includes classification information for each of the products and/or services. For example, a product or service may be classified when it is first offered for sale. In such implementations, the classification unit 112 may simply utilize the classification information available. Alternatively, the product classification engine 114 may examine the existing classifications as well as other information about the products and services and determine at runtime if an existing classification is correct. In another alternative implementation, the product classification engine 114 overlooks existing classifications and classifies the products and/or services at runtime based on information available about the product and/or service, even if a classification already exists. In some implementations, each product and service is categorized once when the system is first initiated. Then reclassifications may be performed periodically to ensure classifications do not become obsolete or inaccurate based on new information. When a new product or service is offered, the classification unit 112 may also be utilized to classify the new product or service.

When classification information for a product and/or service is not available or in implementations where classification occurs at runtime for each product and/or service, data about a product and/or service may be examined to determine a classification. For example, a SKU number associated with the product and/or service may be examined to determine which family of products and/or services the SKU is associated with. Data about the family of products and/or services may then be examined to determine if the family is associated with a particular category. Alternatively, or additionally, information such as product descriptions of products or services may be examined to determine a correct classification. For example, natural language processing (NPL) algorithms may be utilized to examine product and/or service descriptions to identify keywords associated with a category.

The classification unit 112 may also include an offer classification engine 116 for classifying offers. The offer classification 116 may include logic and/or machine-learning (ML) models such as NPL models to examine an offer, identify keywords associated with specific categories, and classify the offer based on the content of the offer. For example, the content of an offer may be examined to determine if any keywords such as government, federal, gov, govern, and the like are included in the content. When such keywords are identified, the offer may be categorized as being associated with the government category. In some implementation, in addition to keywords, order and/or pattern of words, phrases, characters and the like may also be examined. When there is a match of above a given threshold (e.g., above 95%) between the content of an offer and a list of words, patterns, order of words, characters and the like associated with a category, then the offer may be categorized as being associated with that category. When there is no match or the match does not exceed the required threshold, the offer may remain unclassified. In some implementations, unclassified offers may be processed with lower threshold requirements until they can be classified. For example, the order of words may not be taken into account for unclassified offers. In some implementations, additional information about the offer is also taken into account in categorizing the offer. For example, the offer classification engine 116 may examine the types of customers to which an offer is presented, or the type of product or service to which it relates, and take those parameters into account when classifying the offer.

The product classification engine 114 and offer classification engine 116 may operate dynamically and/or automatically, such that the process of classifying products, services and/or offers is automated. For example, when a new product, service or offer is added to the catalog system 152, the catalog server 150 may notify the classification unit 112 automatically to initiate the classification process. The classification unit 112 may then retrieve data about the new product, service or offer from the catalog system 152, and based on the data may transmit a request to the product classification engine 114 or the offer classification engine 116 for classifying the new product, service or offer. Once a product, service or offer is classified by the classification unit 112, the classification information may be transmitted to the catalog system 152 for storage. The classification information may be stored in the data structure used to store other information about the product, service or offer. For example, the classification information may be stored as a property in a product profile for the newly classified product.

In addition to being automated, the process of classifying products, services and offers may be self-learning and feedback based. The self-learning and feedback mechanism may be fully automated or semi-automated. In an example, offers may be occasionally examined manually to ensure they are correctly classified. When an incorrect classification is detected, input may be provided to the product classification engine 112 or offer classification engine 116 to notify of them of the incorrect classification. In some implementations, the correct classification may then be provided. The product classification engine 112 or offer classification engine 116 may utilize the information regarding the incorrect classification and the corrected classification to correct the underlying logics such that future classifications are more accurate.

The tenant classification 122 may be responsible for classifying the tenants of the enterprise into one or more segments. The tenants may include tenant 140A-140N. Each of the tenants 140A-140N may include a computer environment. The computer environment for a tenant may include one or more client computer systems, one or more servers, one or more networks, and the like. Each of the tenants 140A-140N may subscribe to one or more services offered by the enterprise or they may have purchase one of more products offered for sale by the enterprise. Information about the tenants 140A-140N may be stored in the profile system 142. For example, each tenant may be associated with a tenant profile for which data is stored in the profile system 142. Information about the products and/or services a tenant has purchased or licensed may be stored in the subscription system 132.

To classify one or more tenants, the tenant classification unit 122 may include logic for retrieving data from one or more data source systems such as the subscription system 132, profile system 142 and catalog system 152. Once the required data is retrieved, the tenant classification unit 122 may utilize logic to classify one or more tenants of the enterprise. This may involve utilizing a classification engine (not shown) that examines a plurality of parameters associated with a given tenant to classify the tenant. In an example, the classification engine utilizes precedent based and/or rule-based logic. For example, to classify a tenant as belonging to the education managed category, the classification unit may examine a tag associated with the tenant (e.g., a property stored in the profile system 142) to determine if the tenant has an education tag, the tenant has subscribed to or purchased a product or service having an education SKU (e.g., properties of the subscription system 132 and catalog system 152), or the tenant has an offer classified as an education offer (e.g., properties of the profile system 142 and catalog system 152). If one of these conditions is true and a tenant ID identifies the tenant as a major education tenant or education corporate tenant in the tenant profile, then the tenant may be classified as an education managed tenant. To be classified as being belonging to the education non-managed category, the tenant ID may need to carry a true value for education tag, the tenant may need to be associated with only products or services having an education SKU, and the tenant may need to not be classified as either major education or education corporate in the tenant profile. Thus, classification for each category may include specific rules. The rules may take into account various parameters associated with the tenant. These parameters rely on transactional, provisioning, and other types of data associated with each tenant and utilize recently available data such that each classification is performed dynamically and uses real-time information. As a result, the classifications are not static. Furthermore, because the classification process takes various parameters into account, it is more likely to be accurate than classifications that rely on a single parameter.

The rules for classifying each category may be determined and provided by a user and/or may be generated automatically. For example, one or more ML models and/or data science algorithms may be used to generate rules for classifying a tenant as belonging to the education category. The classification rules may be updated periodically to ensure accuracy. For example, if it is determined that a classification rule is resulting in incorrect classifications, the rule may be updated to correct the logic. The correction may be initiated by a user identifying an incorrect classification and updating the rules. Furthermore, the correction may occur automatically when an incorrect classification is identified. When a correction to the rules is made, the next time classification is performed, previous errors are corrected. This means there is no need for restatement of classification data. Because restatement is a serialized process that requires upstream datasets to be restated first, a change to the rules could take a long time to process. Thus, restatement can result in significant latency. Furthermore, storage of historical classification data may require significant memory resources. Because in the technical solution presented herein classification occurs at runtime and is performed dynamically, storage of historical classification data may no longer be required. By using the technical solutions presented herein the need for restating and storing historical classification data may be reduced or eliminated, resulting in reduced processing time, memory use and resources.

It should be noted that, although shown as being part of two different servers, the classification unit 112 and tenant classification unit 122 may be combined into one unit. Furthermore, one or more of the functions discussed here as being performed by the classification unit 112 may be performed by the tenant classification unit 122, and vice versa.

Various elements of the system 100 may be connected to each other via the network 160. For example, each of the servers 110, 120, 130, 140 and 150 may be connected to one another via the network 160. Similarly, the tenants 140A through 140N may be connected to the servers 110, 120, 130, 140 and 150 via the network 160. The network 160 may be a wired or wireless network or a combination of wired and wireless networks and may include a plurality of networks.

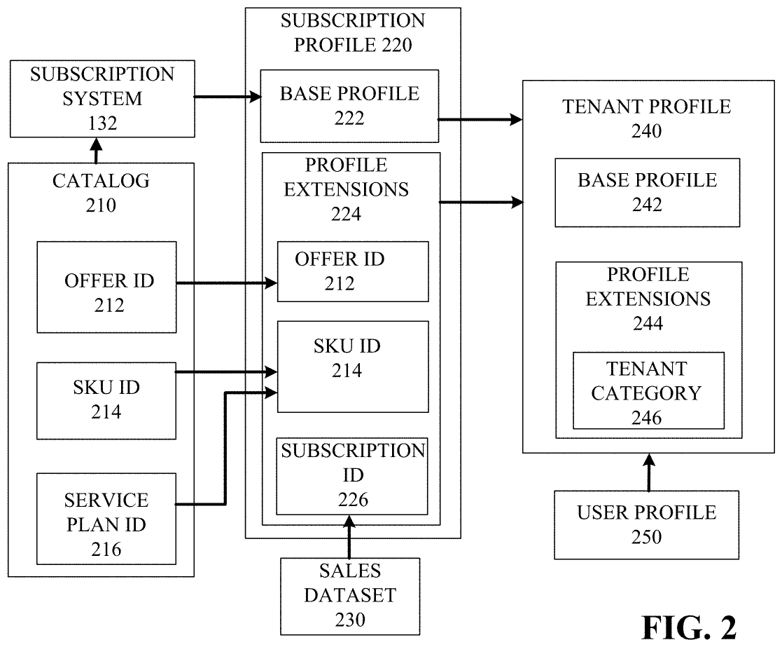

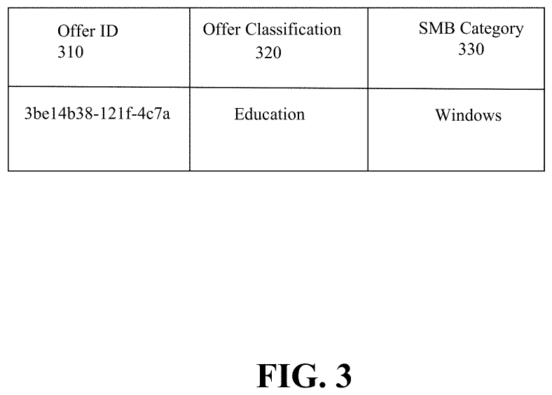

FIG. 2 depicts example data sources used in classifying customers. In some implementations, the catalog data source system (e.g., the catalog system 152) may include a catalog 210, which store data structures associated with an offer ID 212, SKU ID 214 and service plan ID 216. The offer ID 212 may represent multiple data streams such as tabular data streams, where each data stream includes information about a unique offer. Each unique offer may be identified by a unique data entity key (e.g., an offer ID) which serves as the basis for each unique offer. Each offer may be associated with an offer provided by the enterprise. In some implementations, currently valid offers are stored in the catalog. However, a history of previously valid offers may also be stored in the catalog system. The data structure associated with the offer ID may store an identifier (e.g., ID) for each offer in the database. Furthermore, the data structure may store additional parameters for each offer. FIG. 3 depicts an example of some data fields for parameters that may be stored for a given offer ID.

The offer ID field 310 may store an offer identifier for each offer. The offer classification 320 may store an identified classification category for the offer. The classification categories may include education, government, non-profit, commerce and the like. The categories may be the same as categories used for segmenting a tenant. Classifying an offer may be done as described above, with reference to FIG. 1, and the resulting classification category may be stored in the offer classification 320 for the offer. Furthermore, an offer ID may be associated with an offer Server Message Block (SMB) category 330. Examples of SMB categories for a given enterprise include Dynamics, Windows, and not classified for SMB. One or more additional fields may be used to store additional parameters for an offer ID.

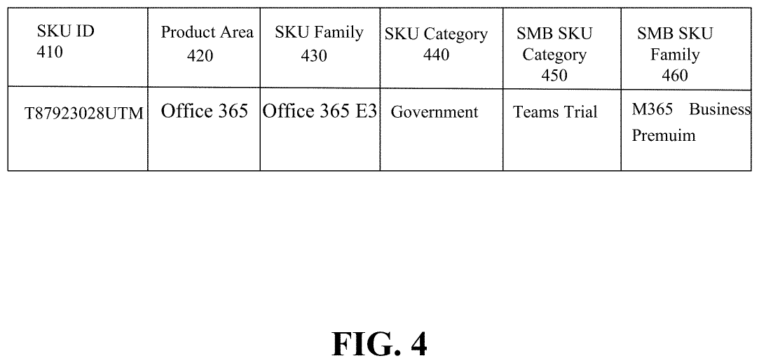

Referring again to FIG. 2, the SKU ID 214 may represent a data structure that stores data associated with a product SKU for a product available for purchase or licensing by the enterprise. The data structure associated with the SKU ID may store a unique key identifier (e.g., SKU ID) for each unique product in the data structure. Furthermore, the data structure may store additional parameters associated with the product. FIG. 4 depicts an example of some data fields for parameters that may be stored for a given SKU ID.

The SKU ID field 410 may store a unique SKU identifier for each SKU. The product area field 420 may store information about the product area to which the product belongs. The SKU family field 430 may store data about the family of products to which the product belongs. Moreover, the SKU category field 440 may store classification information for the category to which the product belongs. The classification categories may include education, government, non-profit, commerce and the like. The categories may be the same as categories used for segmenting a tenant. The category may be identified as discussed above via a classification unit and transmitted to the catalog system for storage with the SKU ID. The data structure may also include an SMB SKU category field 450 for storing information about SMB category to which the product belongs as well as an SMB SKU family field 460 for storing data relating to the SMB family to which the product belongs. It should be noted that data fields associated with each product may vary depending on each enterprise, their products and their needs. However, while many of the data fields for product SKUs may vary and may include additional data fields, the SKU ID and SKU category fields may be included for each product SKU ID across different enterprises to ensure data relating to the classification of each product is stored for use in tenant classification.

Referring again to FIG. 2, the catalog 210 may also include a service plan ID 216 for services offered by the enterprise. The service plan ID may represent a data structure that stores data associated with a service plan ID for a service made available by the enterprise for purchasing or licensing. The data structure associated with the service plan ID may store a unique key identifier (e.g., service plan ID) for each unique service in the data structure. Furthermore, the data structure may store additional parameters associated with the product. The additional parameters may include a service plan category parameter for storing classification information for the category to which the service belongs. The classification categories may include education, government, non-profit, commerce and the like. The categories may be the same as categories used for segmenting a tenant. The category may be identified as discussed above via a classification unit and transmitted to the catalog system for storage with the service plan ID.

Data from the catalog 210 may be transmitted to the subscription system 132 to be used in generating the subscription profile 220. The subscription data profile 220 may represent subscription data which may include data streams that collect data for subscriptions to various products or services. Each unique subscription may be identified by a unique data entity key (e.g., a subscription ID) such as the subscription ID 226. The subscription ID 226 may store subscription IDs for unique subscriptions. Each subscription ID 226 may serve as the basis for a unique subscription profile. A subscription profile may include a base subscription profile 222 and profile extensions 224. The base subscription profile 22 may include data fields such as the subscription ID 226. The subscription ID 226 may be associated with a data field for storing the number of licenses (e.g., number of subscription licenses) granted for that subscription to a given tenant (e.g., 100 license seats for a product to a given tenant). In some implementations, data relating to the subscription ID may be provided by a sales dataset 230. The sales dataset 230 may include information about transactions performed by various tenants. This information may include products and service plans they have purchased.

The profile extensions 224 may include the offer ID 212 and SKU ID 214 and may also include one or more of the data fields associated with each of the offer ID 212 and SKU ID 214. For example, the offer ID 212 as stored in the profile extension of the subscription profile 220 may store a data field for the offer classification. This may result in profile extension fields associated with a subscription ID that includes an offer ID field for the offer associated with the subscription as well as the SKU ID associated with the subscription ID (e.g., tenant is subscribed to a product having a given SKU ID which was offered in an offer having a unique offer ID.

Data from the subscription profile 220, user profile 250 and/or catalog 210 may be transmitted to the profile system 142 of FIG. 1 to generate the tenant profile 240. The tenant profile 240 may represent tenant data, which may include data streams for collecting information about customers (e.g., organizations that subscribe to or buy various services, products, and the like from an enterprise). For example, the tenant data profile 240 may include a data profile for each tenant that has purchased one or more software licenses or has subscribed to one or more software products. Each tenant profile may be identified by a unique data entity key such as a tenant ID. The tenant ID as well as other basic information such as the name of the tenant, date becoming a customer and the like may be stored in tenant base profile 242. Additional information about a tenant such as the number of available units of a product, the number of enabled users, industry, type of cloud tenant and the like may be stored in a profile extension 244. In some implementations, the base profile 242 or profile extensions 244 may include a data field for a tenant classification tag. This may be a classification assigned to the tenant when the tenant first became a customer. This classification may involve manual input by a user associated with the enterprise (e.g., a sales associate who sold the first product to the tenant). The user may examine information provided by the tenant to determine which customer segment the tenant belongs to. In other implementations, the classification may be provided by the tenant when the register. The classification may be revisited and changed periodically by a user. However, because tenant businesses may change overtime and/or since the classification provided by the tenant or determined by the enterprise user may not be correct, reliance on this classification information alone may result in inaccurate classifications for many tenants. To avoid this, the present disclosure makes use of the tenant classification tag as one of many types of input data considered when classifying a tenant. Data from each of the catalog 210, subscription profile 220 and tenant profile 240 may retrieved and used in identifying the appropriate category for a tenant. Once classification is complete, the result may be stored in a tenant category field 246 for each tenant profile 240.

It should be noted that while FIG. 1 depicts one of each of the subscription profile 220, tenant profile 240 and user profile 250, each of the data profiles may represent many such data profiles in the data environment. For example, subscription profile 220 may represent a data profile for each active subscription an enterprise has. Furthermore, the tenant profile 240 may represent a data profile for each tenant of the enterprise. A typical enterprise may include thousands or millions of tenants. The user profile may represent a data profile for each user of the products or services of the enterprise (e.g., each user of each tenant). Thus, each of the data profiles 120, 240 and 250 may represent thousands or millions of individual data profiles.

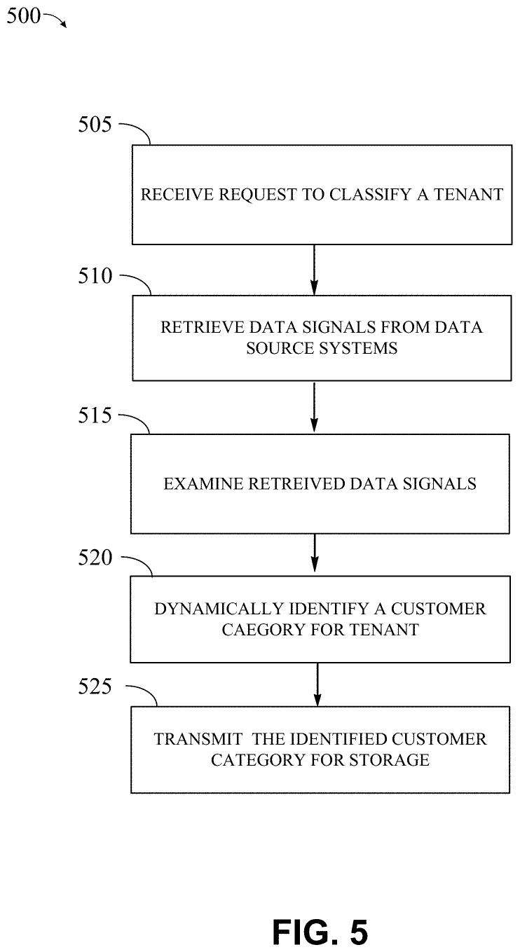

FIG. 5 is a flow diagram depicting an example method 500 for is a flow diagram showing an example method for dynamically classifying a tenant as being associated with one of a plurality of customer categories. In an example, one or more steps of method 500 may be performed by a tenant classification unit such as the tenant classification unit 122 of FIG. 1). Other steps of method 500 may be performed by a storage server or data source server (e.g., servers 132, 142 or 152 of FIG. 14).

At 505, the method 500 may begin by receiving a request to classify a tenant as being associated with one of a plurality of customer categories. The request may be received from a user (e.g., via a user interface element) such as an engineering team member or sales team when reclassification of one or more tenants is needed. Alternatively, the request may be received automatically as part of a periodically tenant performed tenant classification operation. For example, tenant classification may be performed daily or weekly. As such, the process may be initiated via a signal that can be considered a request or an indication of a need for tenant classification for one or more tenants. A request for classification may also be received when a new tenant ID is added to the tenant profile data system.

After receiving the request, method 500 may proceed to receive a plurality of data signals for each tenant for which classification is being performed, at 510. The plurality of data signals may be retrieved from one or more data source systems such as a subscription system, a profile system (e.g., tenant profile) and a catalog system. One or more data signals may be retrieved from each of the one or more data source systems. For example, a tenant ID and tenant classification tag may be retrieved from the profile system, while an offer category for an offer associated with the tenant may be retrieved from the catalog system. To determine which offers and/or products or services the tenant is associated with subscription information may be retrieved from the subscription system.

Once the required data signals are retrieved, method 500 may proceed to examine the retrieved data signals and/or compare them to one or more logical rules associated with classification category, at 515. After the retrieved data signals are reviewed and compared using the logical rules for a given category, method 500 may proceed to dynamically identify a customer category as being associated with the tenant, at 520. This may be done by determining which logical rules the retrieved data signals satisfy, and may involve use of one or more logical algorithms. In some implementations, identifying the customer category may involve utilizing one or more algorithms or ML models.

Once a customer category is identified as being associated with a given tenant, the identified customer category may be transmitted for storage, at 525. This may involve transmitting data relating to the identified customer category and the tenant for which the category was identified to a tenant profile data source system. The tenant profile data source system may then store the identified customer category for the tenant. This information may be used as tenant category for one or more business decisions and other processes that require customer classifications, until the classification process is repeated, and a new customer category is identified for the tenant.

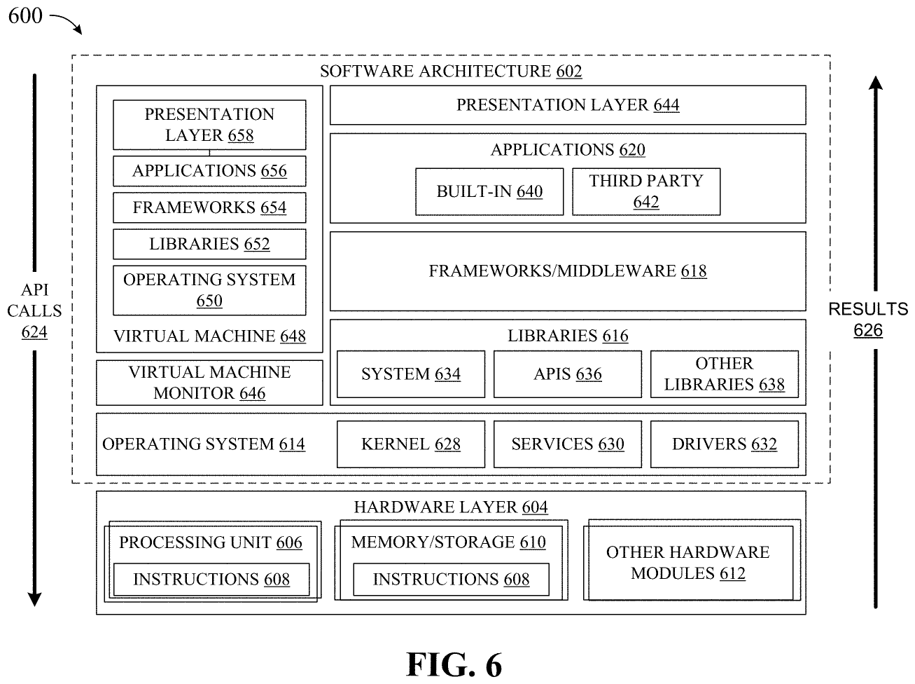

FIG. 6 is a block diagram 600 illustrating an example software architecture 602, various portions of which may be used in conjunction with various hardware architectures herein described, which may implement any of the above-described features. FIG. 6 is a non-limiting example of a software architecture and it will be appreciated that many other architectures may be implemented to facilitate the functionality described herein. The software architecture 602 may execute on hardware such as client devices, native application provider, web servers, server clusters, external services, and other servers. A representative hardware layer 604 includes a processing unit 606 and associated executable instructions 608. The executable instructions 608 represent executable instructions of the software architecture 602, including implementation of the methods, modules and so forth described herein.

The hardware layer 604 also includes a memory/storage 610, which also includes the executable instructions 608 and accompanying data. The hardware layer 604 may also include other hardware modules 612. Instructions 608 held by processing unit 606 may be portions of instructions 608 held by the memory/storage 610.

The example software architecture 602 may be conceptualized as layers, each providing various functionality. For example, the software architecture 602 may include layers and components such as an operating system (OS) 614, libraries 616, frameworks 618, applications 620, and a presentation layer 644. Operationally, the applications 620 and/or other components within the layers may invoke API calls 624 to other layers and receive corresponding results 626. The layers illustrated are representative in nature and other software architectures may include additional or different layers. For example, some mobile or special purpose operating systems may not provide the frameworks/middleware 618.

The OS 614 may manage hardware resources and provide common services. The OS 614 may include, for example, a kernel 628, services 630, and drivers 632. The kernel 628 may act as an abstraction layer between the hardware layer 604 and other software layers. For example, the kernel 628 may be responsible for memory management, processor management (for example, scheduling), component management, networking, security settings, and so on. The services 630 may provide other common services for the other software layers. The drivers 632 may be responsible for controlling or interfacing with the underlying hardware layer 604. For instance, the drivers 632 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 616 may provide a common infrastructure that may be used by the applications 620 and/or other components and/or layers. The libraries 616 typically provide functionality for use by other software modules to perform tasks, rather than rather than interacting directly with the OS 614. The libraries 616 may include system libraries 634 (for example, C standard library) that may provide functions such as memory allocation, string manipulation, file operations. In addition, the libraries 616 may include API libraries 636 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 616 may also include a wide variety of other libraries 638 to provide many functions for applications 620 and other software modules.

The frameworks 618 (also sometimes referred to as middleware) provide a higher-level common infrastructure that may be used by the applications 620 and/or other software modules. For example, the frameworks 618 may provide various graphic user interface (GUI) functions, high-level resource management, or high-level location services. The frameworks 618 may provide a broad spectrum of other APIs for applications 620 and/or other software modules.

The applications 620 include built-in applications 640 and/or third-party applications 642. Examples of built-in applications 640 may include, but are not limited to, a contacts application, a browser application, a location application, a media application, a messaging application, and/or a game application. Third-party applications 642 may include any applications developed by an entity other than the vendor of the particular system. The applications 620 may use functions available via OS 614, libraries 616, frameworks 618, and presentation layer 644 to create user interfaces to interact with users.

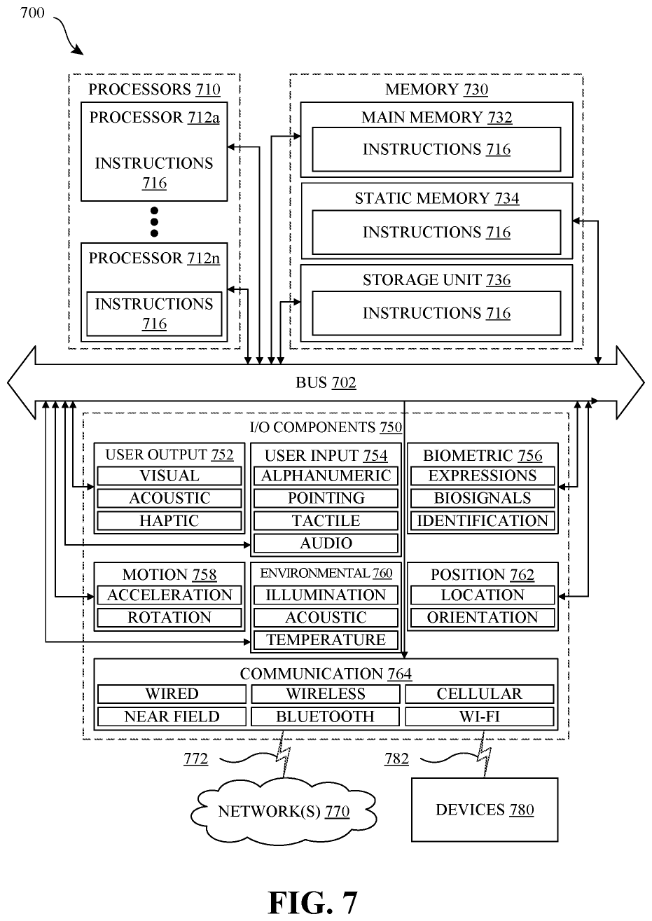

Some software architectures use virtual machines, as illustrated by a virtual machine 648. The virtual machine 648 provides an execution environment where applications/modules can execute as if they were executing on a hardware machine (such as the machine depicted in block diagram 700 of FIG. 7, for example). The virtual machine 648 may be hosted by a host OS (for example, OS 614) or hypervisor, and may have a virtual machine monitor 646 which manages operation of the virtual machine 648 and interoperation with the host operating system. A software architecture, which may be different from software architecture 602 outside of the virtual machine, executes within the virtual machine 648 such as an OS 650, libraries 652, frameworks 654, applications 656, and/or a presentation layer 658.

FIG. 7 is a block diagram showing components of an example machine 700 configured to read instructions from a machine-readable medium (for example, a machine-readable storage medium) and perform any of the features described herein. The example machine 700 is in a form of a computer system, within which instructions 716 (for example, in the form of software components) for causing the machine 700 to perform any of the features described herein may be executed. As such, the instructions 716 may be used to implement methods or components described herein. The instructions 716 cause unprogrammed and/or unconfigured machine 700 to operate as a particular machine configured to carry out the described features. The machine 700 may be configured to operate as a standalone device or may be coupled (for example, networked) to other machines. In a networked deployment, the machine 700 may operate in the capacity of a server machine or a client machine in a server-client network environment, or as a node in a peer-to-peer or distributed network environment. Machine 700 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 700 is illustrated, the term “machine” includes a collection of machines that individually or jointly execute the instructions 716.

The machine 700 may include processors 710, memory 730, and I/O components 750, which may be communicatively coupled via, for example, a bus 702. The bus 702 may include multiple buses coupling various elements of machine 700 via various bus technologies and protocols. In an example, the processors 710 (including, for example, a central processing unit (CPU), a graphics processing unit (GPU), a digital signal processor (DSP), an ASIC, or a suitable combination thereof) may include one or more processors 712a to 712n that may execute the instructions 716 and process data. In some examples, one or more processors 710 may execute instructions provided or identified by one or more other processors 710. The term “processor” includes a multi-core processor including cores that may execute instructions contemporaneously. Although FIG. 7 shows multiple processors, the machine 700 may include a single processor with a single core, a single processor with multiple cores (for example, a multi-core processor), multiple processors each with a single core, multiple processors each with multiple cores, or any combination thereof. In some examples, the machine 700 may include multiple processors distributed among multiple machines.

The memory/storage 730 may include a main memory 732, a static memory 734, or other memory, and a storage unit 736, both accessible to the processors 710 such as via the bus 702. The storage unit 736 and memory 732, 734 store instructions 716 embodying any one or more of the functions described herein. The memory/storage 730 may also store temporary, intermediate, and/or long-term data for processors 710. The instructions 716 may also reside, completely or partially, within the memory 732, 734, within the storage unit 736, within at least one of the processors 710 (for example, within a command buffer or cache memory), within memory at least one of I/O components 750, or any suitable combination thereof, during execution thereof. Accordingly, the memory 732, 734, the storage unit 736, memory in processors 710, and memory in I/O components 750 are examples of machine-readable media.

As used herein, “machine-readable medium” refers to a device able to temporarily or permanently store instructions and data that cause machine 700 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 716) for execution by a machine 700 such that the instructions, when executed by one or more processors 710 of the machine 700, cause the machine 700 to perform and one or more of the features described herein. Accordingly, a “machine-readable medium” may refer to a single storage device, as well as “cloud-based” storage systems or storage networks that include multiple storage apparatus or devices.

The I/O components 750 may include a wide variety of hardware components adapted to receive input, provide output, produce output, transmit information, exchange information, capture measurements, and so on. The specific I/O components 750 included in a particular machine will depend on the type and/or function of the machine. For example, mobile devices such as mobile phones may include a touch input device, whereas a headless server or IoT device may not include such a touch input device. The examples of I/O components illustrated in FIG. 7 are not limiting, and other types of components may be included in machine 700. The grouping of I/O components 750 are merely for simplifying this discussion, and the grouping is in no way limiting. In various examples, the I/O components 750 may include user output components 752 and user input components 754. User output components 752 may include, for example, display components for displaying information (for example, a liquid crystal display (LCD) or a projector), acoustic components (for example, speakers), haptic components (for example, a vibratory motor or force-feedback device), and/or other signal generators. User input components 754 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 750 may include biometric components 756, motion components 758, environmental components 760 and/or position components 762, among a wide array of other environmental sensor components. The biometric components 756 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 762 may include, for example, location sensors (for example, a Global Position System (GPS) receiver), altitude sensors (for example, an air pressure sensor from which altitude may be derived), and/or orientation sensors (for example, magnetometers). The motion components 758 may include, for example, motion sensors such as acceleration and rotation sensors. The environmental components 760 may include, for example, illumination sensors, acoustic sensors and/or temperature sensors.

The I/O components 750 may include communication components 764, implementing a wide variety of technologies operable to couple the machine 700 to network(s) 770 and/or device(s) 780 via respective communicative couplings 772 and 782. The communication components 764 may include one or more network interface components or other suitable devices to interface with the network(s) 770. The communication components 764 may include, for example, components adapted to provide wired communication, wireless communication, cellular communication, Near Field Communication (NFC), Bluetooth communication, Wi-Fi, and/or communication via other modalities. The device(s) 780 may include other machines or various peripheral devices (for example, coupled via USB).

In some examples, the communication components 764 may detect identifiers or include components adapted to detect identifiers. For example, the communication components 764 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 762, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-5) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the following, further features, characteristics and advantages of the invention will be described by means of items:

Item 1. A data processing system comprising:
a processor; and
a memory in communication with the processor, the memory comprising executable instructions that, when executed by, the processor, cause the data processing system to perform functions of:
   receiving a request to classify a tenant as being associated with one of a plurality of customer categories;
   dynamically retrieving from one or more data source systems, a plurality of data signals associated with the tenant, one or more of the plurality of data signals being stored as individual properties for the tenant in the one or more data source systems;
   dynamically identifying, in real-time, the tenant as being associated with one of the plurality of customer categories based at least on the plurality of data signals; and
   transmitting for storage the identified one of the plurality of customer categories as a classification data signal for the tenant.

Item 2. The data processing system of item 1, wherein the one or more data source systems include a subscription data source system, a profile data source system and a catalog data source system.

Item 3. The data processing system of item 2, wherein the subscription data source system includes a data field for a unique subscription identifier key for one or more of subscription profiles in the subscription data source system.

Item 4. The data processing system of item 2, wherein the catalog data source system includes at least one of a first data field for a unique offer identifier key for one or more offers, a second data field for unique SKU identifier key for one or more products and a third data field for a unique service plan identifier key for one or more service plans.

Item 5. The data processing system of item 4, wherein each of the one or more offers is dynamically classified as being associated with one of the plurality of customer categories.

Item 6. The data processing system of item 4, wherein at least one of each of the one or more products or each of the one or more service plans is dynamically classified as being associated with one of the plurality of customer categories.

Item 7. The data processing system of any preceding item, wherein the plurality of data signals include a tenant classification tag.

Item 8. The data processing system of any preceding item, wherein the plurality of data signals include at least one of an offer classification signal, a product classification or a service plan classification for an offer, a product or a service plan with which the tenant is associated.

Item 9. The data processing system of any preceding item, wherein the classification data signal is stored in a tenant profile associated with the tenant in one of the one or more data source systems.

Item 10. A method for classifying a tenant as being associated with one of a plurality of customer categories comprising:
receiving a request to classify the tenant as being associated with the one of a plurality of customer categories;
dynamically retrieving from one or more data source systems, a plurality of data signals associated with the tenant, one or more of the plurality of data signals being stored as individual properties for the tenant in the one or more data source systems;
dynamically identifying, in real-time, the tenant as being associated with one of the plurality of customer categories based at least on the plurality of data signals; and
storing the identified one of the plurality of customer categories as a classification data signal for the tenant.

Item 11. The method of item 10, wherein the one or more data source systems include a subscription data source system, a profile data source system and a catalog data source system.

Item 12. The method of item 11, wherein the catalog data source system includes at least one of a first data field for a unique offer identifier key for one or more offers, a second data field for unique SKU identifier key for one or more products and a third data field for a unique service plan identifier key for one or more service plans.

Item 13. The method of item 12, wherein at least one of each of the one or more offers, one or more products or one or more service plans is dynamically classified as being associated with one of the plurality of customer categories.

Item 14. The method of any of items 10-13, wherein the plurality of data signals include a tenant classification tag.

Item 15. The method of any of items 10-14, wherein the plurality of data signals include at least one of an offer classification signal, a product classification or a service plan classification for an offer, a product or a service plan with which the tenant is associated.

Item 16. The method of any of items 10-15, wherein the classification data signal is stored in a tenant profile associated with the tenant in one of the one or more data source systems.

Item 17. A non-transitory computer readable medium on which are stored instructions that when executed cause a programmable device to perform functions of:
receiving a request to classify a tenant as being associated with one of a plurality of customer categories;
dynamically retrieving from one or more data source systems, a plurality of data signals associated with the tenant, one or more of the plurality of data signals being stored as individual properties for the tenant in the one or more data source systems;
dynamically identifying, in real-time, the tenant as being associated with one of the plurality of customer categories based at least on the plurality of data signals; and
storing the identified one of the plurality of customer categories as a classification data signal for the tenant.

Item 18. The non-transitory computer readable medium of item 17, wherein the one or more data source systems include a subscription data source system, a profile data source system and a catalog data source system.

Item 19. The non-transitory computer readable medium of items 17 or 18, wherein the catalog data source system includes at least one of a first data field for a unique offer identifier key for one or more offers, a second data field for unique SKU identifier key for one or more products and a third data field for a unique service plan identifier key for one or more service plans.

Item 20. The non-transitory computer readable medium of any of items 17-19, wherein the plurality of data signals include at least one of an offer classification signal, a product classification or a service plan classification for an offer, a product or a service plan with which the tenant is associated.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory in communication with the processor, the memory comprising executable instructions that, when executed by the processor, cause the data processing system to perform functions of:
receiving a request to classify a tenant as being associated with one of a plurality of customer categories;
dynamically retrieving from one or more data source systems, a plurality of data signals associated with the tenant, one or more of the plurality of data signals being stored as individual properties for the tenant in the one or more data source systems;
dynamically identifying, in real-time, the tenant as being associated with one of the plurality of customer categories based at least on the plurality of data signals; and
transmitting for storage the identified one of the plurality of customer categories as a classification data signal for the tenant.

2. The data processing system of claim 1, wherein the one or more data source systems include a subscription data source system, a profile data source system and a catalog data source system.

3. The data processing system of claim 2, wherein the subscription data source system includes a data field for a unique subscription identifier key for one or more of subscription profiles in the subscription data source system.

4. The data processing system of claim 2, wherein the catalog data source system includes at least one of a first data field for a unique offer identifier key for one or more offers, a second data field for unique SKU identifier key for one or more products and a third data field for a unique service plan identifier key for one or more service plans.

5. The data processing system of claim 4, wherein each of the one or more offers is dynamically classified as being associated with one of the plurality of customer categories.

6. The data processing system of claim 4, wherein at least one of each of the one or more products or each of the one or more service plans is dynamically classified as being associated with one of the plurality of customer categories.

7. The data processing system of claim 1, wherein the plurality of data signals include a tenant classification tag.

8. The data processing system of claim 1, wherein the plurality of data signals include at least one of an offer classification signal, a product classification or a service plan classification for an offer, a product or a service plan with which the tenant is associated.

9. The data processing system of claim 1, wherein the classification data signal is stored in a tenant profile associated with the tenant in one of the one or more data source systems.

10. A method for classifying a tenant as being associated with one of a plurality of customer categories comprising:
receiving a request to classify the tenant as being associated with the one of a plurality of customer categories;
dynamically retrieving from one or more data source systems, a plurality of data signals associated with the tenant, one or more of the plurality of data signals being stored as individual properties for the tenant in the one or more data source systems;
dynamically identifying, in real-time, the tenant as being associated with one of the plurality of customer categories based at least on the plurality of data signals; and
storing the identified one of the plurality of customer categories as a classification data signal for the tenant.

11. The method of claim 10, wherein the one or more data source systems include a subscription data source system, a profile data source system and a catalog data source system.

12. The method of claim 11, wherein the catalog data source system includes at least one of a first data field for a unique offer identifier key for one or more offers, a second data field for unique SKU identifier key for one or more products and a third data field for a unique service plan identifier key for one or more service plans.

13. The method of claim 12, wherein at least one of each of the one or more offers, one or more products or one or more service plans is dynamically classified as being associated with one of the plurality of customer categories.

14. The method of claim 10, wherein the plurality of data signals include a tenant classification tag.

15. The method of claim 10, wherein the plurality of data signals include at least one of an offer classification signal, a product classification or a service plan classification for an offer, a product or a service plan with which the tenant is associated.

16. The method of claim 10, wherein the classification data signal is stored in a tenant profile associated with the tenant in one of the one or more data source systems.

17. A non-transitory computer readable medium on which are stored instructions that when executed cause a programmable device to perform functions of:
receiving a request to classify a tenant as being associated with one of a plurality of customer categories;
dynamically retrieving from one or more data source systems, a plurality of data signals associated with the tenant, one or more of the plurality of data signals being stored as individual properties for the tenant in the one or more data source systems;
dynamically identifying, in real-time, the tenant as being associated with one of the plurality of customer categories based at least on the plurality of data signals; and
storing the identified one of the plurality of customer categories as a classification data signal for the tenant.

18. The non-transitory computer readable medium of claim 17, wherein the one or more data source systems include a subscription data source system, a profile data source system and a catalog data source system.

19. The non-transitory computer readable medium of claim 17, wherein the catalog data source system includes at least one of a first data field for a unique offer identifier key for one or more offers, a second data field for unique SKU identifier key for one or more products and a third data field for a unique service plan identifier key for one or more service plans.

20. The non-transitory computer readable medium of claim 17, wherein the plurality of data signals include at least one of an offer classification signal, a product classification or a service plan classification for an offer, a product or a service plan with which the tenant is associated.
